(19) United States
(12) Patent Application Publication
(10) Pub. No.: US 2003/0081623 A1
(43) Pub. Date: May 1, 2003

(54) Virtual queues in a single queue in the bandwidth management traffic-shaping cell

(75) Inventors: Frederick Kiremidjian, Danville, CA (US); Li-Ho Raymond Hou, Saratoga, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: AMPLIFY.NET, INC.

(21) Appl. No.: 10/004,078

(22) Filed: Oct. 27, 2001

(51) Int. Cl. H04L 12/28

(52) U.S. Cl. 370/412

(57) ABSTRACT

A method comprises using a class-based queue traffic shaper that enforces multiple service-level agreement policies on individual connection sessions by limiting the maximum data throughput for each connection. The class-based queue traffic shaper distinguishes amongst datapackets according to their respective source and/or destination IP-addresses. Each of the service-level agreement policies maintains a statistic that tracks how many datapackets are being buffered at any one instant. A test is made of each policy's statistic for each newly arriving datapacket. If the policy associated with the datapacket's destination is currently buffering, or holding, any datapackets, then the newly arriving datapacket is sent to be buffered too. This allows the longest waiting datapacket for the particular destination to be released and cleared from the buffer first.

### BACKGROUND OF THE INVENTION

1. Field of the Invention

The invention relates generally to computer network protocols and equipment for adjusting datapacket-by-datapacket bandwidth according to the source and/or destination IP-addresses of each such datapacket. More specifically, the present invention relates to preserving datapacket order in hierarchical networks when individual network nodes are subject to bandwidth-allocation controls.

2. Description of the Prior Art

Access bandwidth is important to Internet users. New cable, digital subscriber line (DSL), and wireless “alwayson” broadband-access together are expected to eclipse dial-up Internet access in 2001. So network equipment vendors are scrambling to bring a new generation of broadband access solutions to market for their service-provider customers. These new systems support multiple high speed data, voice and streaming video Internet-protocol (IP) services, and not just over one access media, but over any media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad,” it is always “shared” at some point and the total bandwidth is not unlimited. All broadband pipes must therefore be carefully and efficiently managed.

Internet Protocol (IP) datapackets are conventionally treated as equals, and therein lies one of the major reasons for its “log jams”. When all IP-datapackets have equal right-of-way over the Internet, a “first come, first serve” service arrangement results. The overall response time and quality of delivery service is promised to be on a “best effort” basis only. Unfortunately all IP-datapackets are not equal, certain classes of IP-datapackets must be processed differently.

In the past, such traffic congestion has caused no fatal problems, only an increasing frustration from the unpredictable and sometimes gross delays. However, new applications use the Internet to send voice and streaming video IP-datapackets that mix-in with the data IP-datapackets. These new applications cannot tolerate a classless, best efforts delivery scheme, and include IP-telephony, pay-per-view movie delivery, radio broadcasts, cable modem (CM), and cable modem termination system (CMTS) over two-way transmission hybrid fiber/coax (HFC) cable.

Internet service providers (ISPs) need to be able to automatically and dynamically integrate service subscription orders and changes, e.g., for “on demand” services. Different classes of services must be offered at different price points and quality levels. Each subscriber's actual usage must be tracked so that their monthly bills can accurately track the service levels delivered. Each subscriber should be able to dynamically order any service based on time of day/week, or premier services that support merged data, voice and video over any access broadband media, and integrate them into a single point of contact for the subscriber.

There is an urgent demand from service providers for network equipment vendors to provide integrated broadband-access solutions that are reliable, scalable, and easy to use. These service providers also need to be able to manage and maintain ever growing numbers of subscribers.

Conventional IP-addresses, as used by the Internet, rely on four-byte hexadecimal numbers, e.g., OOH-FFH. These are typically expressed with four sets of decimal numbers that range 0-255 each, e.g., “192.55.0.1”. A single look-up table could be constructed for each of 4,294,967,296 (256⁴) possible IP-addresses to find what bandwidth policy should attach to a particular datapacket passing through. But with only one byte to record the policy for each IP-address, that approach would require more than four gigabytes of memory. So this is impractical.

There is also a very limited time available for the bandwidth classification system to classify a datapacket before the next datapacket arrives. The search routine to find which policy attaches to a particular IP-address must be finished within a finite time. And as the bandwidths get higher and higher, these search times get proportionally shorter.

The straight forward way to limit-check each node in a hierarchical network is to test whether passing a just received datapacket would exceed the policy bandwidth for that node. If yes, the datapacket is queued for delay. If no, a limit-check must be made to see if the aggregate of this node and all other daughter nodes would exceed the limits of a parent node. And then a grandparent node, and so on. Such sequential limit check of hierarchical nodes was practical in software implementations hosted on high performance hardware platforms. But it is impractical in a pure hardware implementation, e.g., a semiconductor integrated circuit.

The TCP/IP protocol allows datapackets to become dislodged from their original order during their journey, the destination client is required to restore the original order. But this process is subject to time delays and errors, so it is best not to scramble datapacket order through a local network if it can be avoided. This is especially true for the parts of the network nearest the destination. In networks that control network node bandwidth by delaying datapackets that would otherwise exceed some service level policy, it can happen that a later arriving datapacket would immediately find a greenlite to the destination. So the opportunity to release a datapacket being held in the buffer for that same destination would be snatched away. The result would be out-of-order delivery.

### SUMMARY OF THE PRESENT INVENTION

It is therefore an object of the present invention to provide a semiconductor intellectual property for controlling network bandwidth at a local site according to a predetermined policy.

It is another object of the present invention to provide a semiconductor intellectual property that implements in hardware a traffic-shaping cell that can control network bandwidth at very high datapacket rates and in real time.

It is a further object of the present invention to provide a method for bandwidth traffic-shaping that can control network bandwidth at very high datapacket rates and still preserve datapacket order for each local destination.

Briefly, a method embodiment of the present invention comprises a class-based queue traffic shaper that enforces multiple service-level agreement policies on individual connection sessions by limiting the maximum data throughput for each connection. The class-based queue traffic shaper distinguishes amongst datapackets according to their respective source and/or destination IP-addresses. Each of the service-level agreement policies maintains a statistic that tracks how many datapackets are being buffered at any one instant. A test is made of each policy's statistic for each newly arriving datapacket. If the policy associated with the datapacket's destination is currently buffering, or holding, any datapackets, then the newly arriving datapacket is sent to be buffered too. This allows the longest waiting datapacket for the particular destination to be released and cleared from the buffer first.

An advantage of the present invention is a device and method are provided for allocating bandwidth to network nodes according to a policy, and while preserving datapacket order to each destination.

A still further advantage of the present invention is a semiconductor intellectual property is provided that makes datapacket transfers according to service-level agreement policies in real time and at high datapacket rates.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a schematic diagram of a hierarchical network embodiment of the present invention with a gateway to the Internet;

FIG. 2A is a diagram of a single queue embodiment of the present invention for checking and enforcing bandwidth service level policy management in a hierarchical network;

FIG. 2B is a diagram of a datapacket-order preservation embodiment of the present invention wherein several service-level policies each maintain a statistic related to how many datapackets are being buffered at network nodes for particular destinations; and

FIG. 3 is a functional block diagram of a system of interconnected semiconductor chip components that include a traffic-shaping cell and classifier, and that implements various parts of FIGS. 1, 2A and 2B.

### DETAILED DESCRIPTION OF THE PREFERRED EMBODIMENTS

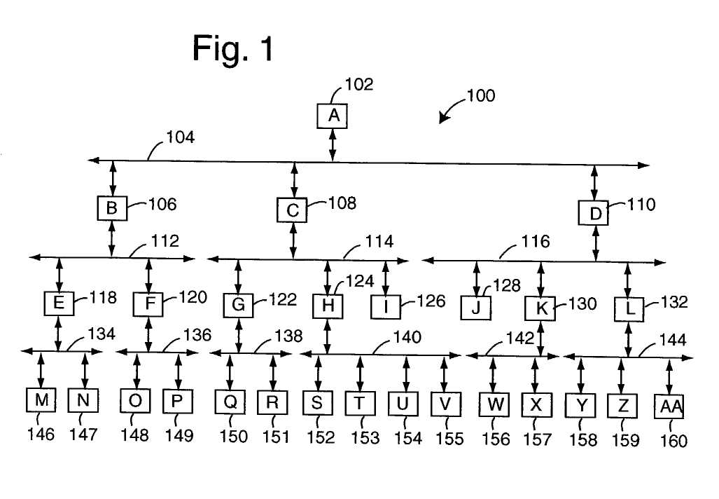

FIG. 1 represents a hierarchical network embodiment of the present invention, and is referred to herein by the general reference numeral 100. The network 100 has a hierarchy that is common in cable network systems. Each higher level node and each higher level network is capable of data bandwidths much greater than those below it. But if all lower level nodes and networks were running at maximum bandwidth, their aggregate bandwidth demands would exceed the higher level's capabilities.

The network 100 therefore includes bandwidth management that limits the bandwidth made available to daughter nodes, e.g., according to a paid service-level policy. Higher bandwidth policies are charged higher access rates. Even so, when the demands on all the parts of a branch exceed the policy for the whole branch, the lower-level demands are trimmed back. For example, to keep one branch from dominating trunk-bandwidth to the chagrin of its peer branches.

The present Assignee, Amplify.net, Inc., has filed several United States Patent Applications that describe such service-level policies and the mechanisms to implement them. Such include INTERNET USER-BANDWIDTH MANAGEMENT AND CONTROL TOOL, now U.S. Pat. No. 6,085,241, issued Mar. 14, 2000; BANDWIDTH SCALING DEVICE, Ser. No. 08/995,091, filed Dec. 19, 1997; BANDWIDTH ASSIGNMENT HIERARCHY BASED ON BOTTOM-UP DEMANDS, Ser. No. 09/718,296, filed Nov. 21, 2000; NETWORK-BANDWIDTH ALLOCATION WITH CONFLICT RESOLUTION FOR OVERRIDE, RANK, AND SPECIAL APPLICATION SUPPORT, Ser. No. 09/716,082, filed Nov. 16, 2000; GRAPHICAL USER INTERFACE FOR DYNAMIC VIEWING OF DATAPACKET EXCHANGES OVER COMPUTER NETWORKS, Ser. No. 09/729,733, filed Dec. 14, 2000; ALLOCATION OF NETWORK BANDWIDTH ACCORDING TO NETWORK APPLICATION, Ser. No. 09/718,297, filed Nov. 21, 2001; METHOD FOR ASCERTAINING NETWORK BANDWIDTH ALLOCATION POLICY ASSOCIATED WITH APPLICATION PORT NUMBERS, (Docket SS-709-07) Ser. No. ______, filed Aug. 2, 2001; and METHOD FOR ASCERTAINING NETWORK BANDWIDTH ALLOCATION POLICY ASSOCIATED WITH NETWORK ADDRESS, (Docket SS-709-08) Ser. No. ______, filed Aug. 7,2001. All of which are incorporated herein by reference.

Suppose the network 100 represents a city-wide cable network distribution system. A top trunk 102 provides a broadband gateway to the Internet and it services a top main trunk 104, e.g., having a maximum bandwidth of 100-Mbps. At the next lower level, a set of cable modem termination systems (CMTS) 106, 108, and 110, each classifies traffic into data, voice and video 112, 114, and 116. If each of these had bandwidths of 45-Mbps, then all three running at maximum would need 135-Mbps at top main trunk 104 and top gateway 102. A policy-enforcement mechanism is included that limits, e.g., each CMTS 106, 108, and 110 to 45-Mbps and the top Internet trunk 102 to 100-Mbps. If all traffic passes through the top Internet trunk 102, such policy-enforcement mechanism can be implemented there alone.

Each CMTS supports multiple radio frequency (RF) channels 118, 120, 122, 124, 126, 128, 130, and 132, which are limited to a still lower bandwidth, e.g., 38-Mbps each. A group of neighborhood networks 134, 136, 138, 140, 142, and 144, distribute bandwidth to end users 146-160, e.g., individual cable network subscribers residing along neighborhood streets. Each of these could buy 5-Mbps bandwidth service level policies, for example.

Each node can maintain a management queue to control traffic passing through it. Several such queues can be collectively managed by a single controller, and a hierarchical network would ordinarily require the several queues to be dealt with sequentially. Here, such several queues are collapsed into a single queue that is checked broadside in a single clock.

But single queue implementations require an additional mechanism to maintain the correct sequence of datapackets released by a traffic shaping manager, e.g., a TS cell. When a new datapacket arrives the user nodes and parent nodes are classified to elicit the corresponding service-level policies.

For example, suppose a previously received datapacket for a user node was queued because there were not enough bandwidth credits. Then a new datapacket for the same user node arrives just as the TS cell finishes its periodical credit replenishment process. Ordinarily, a check of bandwidth credits here would find some available, and so the new datapacket would be forwarded. That is, out of sequence because the earlier datapacket was still in the queue. It could further develop that the datapacket still in the queue would continue to find a shortage of bandwidth credits and be held in the buffer even longer.

The better policy, as used in embodiments of the present invention, is to hold newly arriving datapackets for a user node if any previously received datapackets for that user node are in the queue. In a single queue implementation then, the challenge is in constructing a mechanism for the TS cell to detect whether there are other datapackets that belong to the same user nodes that are being queued.

Embodiments of the present invention use a virtual queue count for each user node. Each user node includes a virtual queue count that accumulates the number of datapackets currently queued in the single queue due to lack of available credit in the user node or in one of the parent nodes. When a datapacket is queued, a TS cell increments such count by one. When a datapacket is released from the queue, the count is decremented by one. Therefore, when a new datapacket arrives, if the queued-datapacket count is not zero, the datapacket is queued. This, without trying the parallel limit checking. Such maintains a correct datapacket sequence and it saves processing time.

The TS cell periodically scans the single queue to check if any of the queued datapacket can be released, e.g., because new credits have been replenished to node data structure. If a queued datapacket for a user node still lacks credits at any one of the corresponding nodes, then other datapackets for the user node in a subsequent scan will not be released if the datapacket will be released out of sequence, even if that datapacket has enough bandwidth credit itself to be sent.

Embodiments of the present invention can use a “scan flag” in each user node. The TS cell typically resets all flags in every user node before the queue scan starts. It sets a flag when it processes a queued datapacket and the determination is made to continue it in the queue. When the TS cell processes a datapacket, it first uses the pointer to the user node in the queue entry to check if the flag is set or not. If it is set, then it does not need to do a parallel limit check, and just skips to the next entry in the queue. If the flag is not set, it then checks if a queued datapacket can be released.

Some embodiments of the present invention combine a virtual queue count and a scan flag, e.g., a virtual queue flag. Just like the scan flag, the virtual queue flag is reset before the TS cell starts a new scan. The virtual queue flag is set when a queued datapacket is scanned and the result is continued queuing. During the scan, if the virtual queue flag corresponding to the user node of the queued entry is already set, the queued entry is skipped without performing a parallel limit check. When a new datapacket arrives in between two scans, it also uses such virtual queue flag to determine whether it needs to do a parallel limit check. If the flag is set, the newly arrived datapacket is queued automatically without a limit check. When a parallel limit check is performed and the result is queuing the datapacket, the flag is set by the TS cell. When a new datapacket arrives during a queue scan by the TS cell, the newly arrived datapackets will be queued automatically and they are processed by the queue scan which is already in progress. This mechanism prevents out of order datapacket release because the virtual queue flag is reset at the beginning of the scan and the scan is not finished yet. If there is no datapacket in the queue and the queue scan reaches this new datapacket, the parallel check will be done to determine whether it should be released.

The integration of class-based queues and datapacket classification mechanisms in semiconductor chips necessitates more efficient implementations, especially where bandwidths are exceedingly high and the time to classify and policy-check each datapacket is exceedingly short. Therefore, embodiments of the present invention describes a new approach which manages every datapacket in the whole network 100 from a single queue. Rather, as in previous embodiments, than maintaining queues for each node A-Z, and AA, and checking the bandwidth limit of all hierarchical nodes at all four levels in a sequential manner to see if a datapacket should be held or forwarded. Embodiments of the present invention manage every datapacket through every node in the network with one single queue and checks the bandwidth limit at relevant hierarchical nodes simultaneously in a parallel architecture.

Each entry in the single queue includes fields for the pointer to the present source or destination node (user node), and all higher level nodes (parent nodes). The bandwidth limit of every node pointed to by this entry is tested in one clock cycle in parallel to see if enough credit exists at each node level to pass the datapacket along.

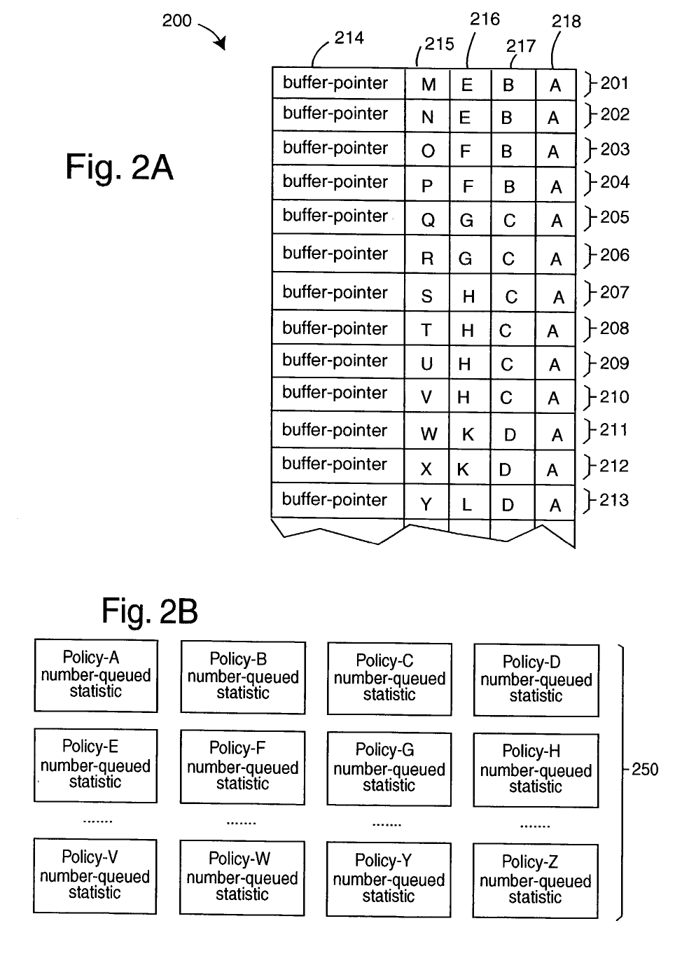

FIG. 2A illustrates a single queue 200 and several entries 201-213. A first entry 201 is associated with a datapacket sourced from or destined for subscriber node (M) 146. If such datapacket needs to climb the hierarchy of network 100 (FIG. 1) to access the Internet, the service level policies of the user node (M) 146 and parent nodes (E) 118, (B) 106 and (A) 102 will all be involved in the decision whether or not to forward the datapacket or delay it. Similarly, another entry 212 is associated with a datapacket sourced from or destined for subscriber node (X) 157. If such datapacket also needs to climb the hierarchy of network 100 (FIG. 1) to access the Internet, the service level policies of nodes (X) 157, (K) 130, (D) 110 and (A) 102 will all be involved in the decision whether or not to forward such datapacket or delay it.

There are many ways to implement the queue 200 and the fields included in each entry 201-213. The instance of FIG. 2 is merely exemplary. A buffer-pointer field 214 points to where the actual data for the datapacket resides in a buffer memory, so that the queue 200 doesn't have to spend time and resources shuffling the whole datapacket header and payload around. A credit field 215-218 is divided into four subfields that represent the four possible levels of the hierarchy for each subscriber node 146-160 or nodes 126 and 128.

A calculation periodically deposits credits in each four subcredit fields to indicate the availability of bandwidth, e.g., one credit for enough bandwidth to transfer one datapacket through the respective node. When a decision is made to either forward or hold a datapacket represented by each corresponding entry 201-213, the credit field 217 is inspected. If all subfields indicate a credit and none are zero, then the respective datapacket is forwarded through the network 100 and the entry cleared from queue 200. The consumption of the credit is reflected in a decrement of each involved subfield. For example, if the inspection of entry 201 resulted in the respective datapacket being forwarded, the credits for nodes M, E, B, and A would all be decremented for entries 202-213. This may result in zero credits for entry 202 at the E, B, or A levels. If so, the corresponding datapacket for entry 202 would be held.

The single queue 200 also prevents datapackets from-or-to particular nodes from being passed along out of order. The TCP/IP protocol allows and expects datapackets to arrive in random order, but network performance and reliability is best if datapacket order is preserved.

The service-level policies are defined and input by a system administrator. Internal hardware and software are used to spool and despool datapacket streams through at the appropriate bandwidths. In business model implementations of the present invention, subscribers are charged various fees for different levels of service, e.g., better bandwidth and delivery time-slots.

A network embodiment of the present invention comprises a local group of network workstations and clients with a set of corresponding local IP-addresses. Those local devices periodically need access to a wide area network (WAN). A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of datapacket can be limited to a different connection-bandwidth than another session-connection involving a second type of datapacket. The SLA policies are attached to each and every local IP-address, and any connection-combinations with outside IP-addresses can be ignored.

FIG. 2B illustrates a few of the service level policies 250 included for use in FIGS. 1 and 2A. Each policy maintains a statistic related to how many datapackets are being buffered for a corresponding network node, e.g., A-Z and AA. A method embodiment of the present invention classifies all newly arriving datapackets according to which network nodes they must pass and the corresponding service-level policies involved. Each service-level policy statistic is consulted to see if any datapackets are being buffered, e.g., to delay delivery to the destination to keep the network-node bandwidth within service agreement levels. If there is even one such datapacket being held in the buffer, then the newly arriving datapacket is sent to the buffer too. This occurs without regard to whether enough bandwidth-allocation credits currently exist to otherwise pass the datapacket through. The objective here is to guarantee that the earliest arriving datapackets being held in the buffer will be delivered first. When enough “credits” are collected to send the earliest datapacket in the queue, it is sent even before smaller but later arriving datapackets.

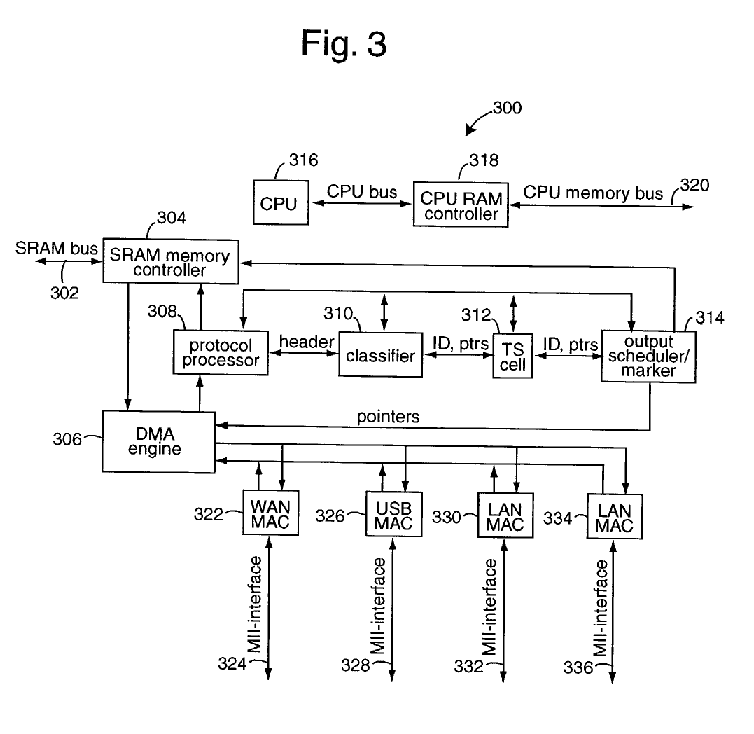

FIG. 3 represents a bandwidth management system 300 in an embodiment of the present invention. The bandwidth management system 300 is preferably implemented in semiconductor integrated circuits (IC's). The bandwidth management system 300 comprises a static random access memory (SRAM) bus 302 connected to an SRAM memory controller 304. A direct memory access (DMA) engine 306 helps move blocks of memory in and out of an external SRAM array. A protocol processor 308 parses application protocol to identify the dynamically assigned TCP/UDP port number then communicates datapacket header information with a datapacket classifier 310. Datapacket identification and pointers to the corresponding service level agreement policy are exchanged with a traffic shaping (TS) cell 312 implemented as a single chip or synthesizable semiconductor intellectual property (SIA) core. Such datapacket identification and pointers to policy are also exchanged with an output scheduler and marker 314. A microcomputer (CPU) 316 directs the overall activity of the bandwidth management system 300, and is connected to a CPU RAM memory controller 318 and a RAM memory bus 320. External RAM memory is used for execution of programs and data for the CPU 316. The external SRAM array is used to shuffle the network datapackets through according to the appropriate service level policies.

The datapacket classifier 310 first identifies the end user service level policy (the policy associated with nodes 146-160). Every end user policy also has its corresponding policies associated with all parent nodes of this user node. The classifier passes an entry that contains a pointer to the datapacket itself that resides in the external SRAM and the pointers to all corresponding nodes for this datapacket, i.e. the user nodes and its parent node. Each node contains the service level agreement policies such as bandwidth limit (CR and MBR) and the current available credit for a datapacket to go through.

A variety of network interfaces can be accommodated, either one type at a time, or many types in parallel. When in parallel, the protocol processor 308 aids in translations between protocols, e.g., USB and TCP/IP. For example, a wide area network (WAN) media access controller (MAC) 322 presents a media independent interface (MII) 324, e.g., 100BaseT fast Ethernet. A universal serial bus (USB) MAC 326 presents a media independent interface (MII) 328, e.g., using a USB-2.0 core. A local area network (LAN) MAC 330 has an MII connection 332. A second LAN MAC 334 also presents an MII connection 336. Other protocol and interface types include home phoneline network alliance (HPNA) network, IEEE-802.11 wireless, etc. Datapackets are received on their respective networks, classified, and either sent along to their destination or stored in SRAM to effectuate bandwidth limits at various nodes, e.g., “traffic shaping”.

The protocol processor 308 is implemented as a table-driven state engine, with as many as two hundred and fifty-six concurrent sessions and sixty-four states. The die size for such an IC is currently estimated at 20.00 square millimeters using 0.18 micron CMOS technology. Alternative implementations may control 20,000 or more independent policies, e.g., community cable access system.

The classifier 310 preferably manages as many as two hundred and fifty-six policies using IP-address, MAC-address, port-number, and handle classification parameters. Content addressable memory (CAM) can be used in a good design implementation. The die size for such an IC is currently estimated at 3.91 square millimeters using 0.18 micron CMOS technology.

The traffic shaping (TS) cell 312 preferably manages as many as two hundred and fifty-six policies using CIR, MBR, virtual-switching, and multicast-support shaping parameters. A typical TS cell 312 controls three levels of network hierarchy, e.g., as in FIG. 1. A single queue is implemented to preserve datapacket order, as in FIG. 2. Such TS cell 312 is preferably self-contained with its on chip-based memory. The die size for such an IC is currently estimated at 2.00 square millimeters using 0.18 micron CMOS technology.

The output scheduler and marker 314 schedules datapackets according to DiffServ Code Points and datapacket size. The use of a single queue is preferred. Marks are inserted according to parameters supplied by the TS cell 312, e.g., DiffServ Code Points. The die size for such an IC is currently estimated at 0.93 square millimeters using 0.18 micron CMOS technology.

The CPU 316 is preferably implemented with an ARM740T core processor with 8K of cache memory. MIPS and POWER-PC are alternative choices. Cost here is a primary driver, and the performance requirements are modest. The die size for such an IC is currently estimated at 2.50 square millimeters using 0.18 micron CMOS technology. The control firmware supports four provisioning models: TFTP/Conf_file, simple network management protocol (SNMP), web-based, and dynamic. The TFTP/Conf_file provides for batch configuration and batch-usage parameter retrieval. The SNMP provides for policy provisioning and updates. User configurations can be accommodated by web-based methods. The dynamic provisioning includes auto-detection of connected devices, spoofing of current state of connected devices, and on-the-fly creation of policies.

In an auto-provisioning example, when a voice over IP (VoIP) service is enabled the protocol processor 308 is set up to track SIP, or CQOS, or both. As the VoIP phone and the gateway server run the signaling protocol, the protocol processor 308 extracts the IP-source, IP-destination, port-number, and other appropriate parameters. These are then passed to CPU 316 which sets up the policy, and enables the classifier 310, the TS cell 312, and the scheduler 314, to deliver the service.

If the bandwidth management system 300 were implemented as an application specific programmable processor (ASPP), the die size for such an IC is currently estimated at 35.72 square millimeters, at 100% utilization, using 0.18 micron CMOS technology. About one hundred and ninety-four pins would be needed on the device package. In a business model embodiment of the present invention, such an ASPP version of the bandwidth management system 300 would be implemented and marketed as hardware description language (HDL) in semiconductor intellectual property (SIA) form, e.g., Verilog code.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A method for managing the distribution of datapackets, the method comprising the steps of:
associating a service-level policy that limits allowable bandwidths to particular nodes in a hierarchical network;
classifying datapackets moving through said hierarchical network according to a particular service-level policy;
delaying any said datapackets in a buffer to enforce said service-level policy;
maintaining a statistic for each said particular service-level policy related to how many said datapackets are in said buffer at any one instant;
sending any newly arriving datapackets to said buffer simply if a corresponding service-level policy statistic indicates any other earlier arriving datapackets related to the same service-level policy are currently being buffered; and
managing all datapackets moving through said hierarchical network from a queue in which each entry includes service-level policy bandwidth allowances for every hierarchical node in said network through which a corresponding datapacket must pass.

2. The method of claim 1, further comprising the step of:
testing in parallel whether a particular datapacket should be delayed in a buffer or sent along for every hierarchical node in said network through which it must pass.

3. The method of claim 1, further comprising the step of:
constructing a single queue of entries associated with corresponding datapackets passing through said hierarchical network such that each entry includes source and destination header information and any available bandwidth credits for every hierarchical node in said network through which a corresponding datapacket must pass.

4. A means for managing the distribution of datapackets, comprising:
means for associating a service-level policy that limits allowable bandwidths to particular nodes in a hierarchical network;
means for classifying datapackets moving through said hierarchical network according to a particular service-level policy;
means for delaying any said datapackets in a buffer to enforce said service-level policy;
means for maintaining a statistic for each said particular service-level policy related to how many said datapackets are in said buffer at any one instant;
means for sending any newly arriving datapackets to said buffer simply if a corresponding service-level policy statistic indicates any other earlier arriving datapackets related to the same service-level policy are currently being buffered; and
means for managing all datapackets moving through said hierarchical network from a queue in which each entry includes service-level policy bandwidth allowances for every hierarchical node in said network through which a corresponding datapacket must pass.

5. The means of claim 4, further comprising:
means for testing in parallel whether a particular datapacket should be delayed in a buffer or sent along for every hierarchical node in said network through which it must pass.

6. The means of claim 4, further comprising:
means for constructing a single queue of entries associated with corresponding datapackets passing through said hierarchical network such that each entry includes source and destination header information and any available bandwidth credits for every hierarchical node in said network through which a corresponding datapacket must pass.

7. A network management system, comprising:
a protocol processor providing for header inspection of datapackets circulating through a network and providing for an information output comprising at least one of source IP-address, destination IP-address, port number, and application type;
a classifier connected to receive said information output and able to associate a particular datapacket with a particular network node and a corresponding service-level policy bandwidth allowance;
a single queue comprising individual entries related to said datapackets circulating through said network, and further related to all network nodes through which each must pass; and
a traffic-shaping cell providing for an inspection of each one of said individual entries and for outputting a single decision whether to pass through or buffer each of said datapackets in all network nodes through which each must pass;
wherein, means datapackets in a buffer are delayed to enforce said service-level policy, and a statistic is maintained for each said particular service-level policy related to how many said datapackets are in said buffer at any one instant, and any newly arriving datapackets are sent to said buffer simply if a corresponding service-level policy statistic indicates any other earlier arriving datapackets related to the same service-level policy are currently being buffered, and all datapackets moving through said hierarchical network from a queue are controlled in which each entry includes service-level policy bandwidth allowances for every hierarchical node in said network through which a corresponding datapacket must pass.

8. The system of claim 7, further comprising:
an output scheduler and marker for identifying particular ones of the individual entries in the single queue that are to be passed through or buffered.

9. The system of claim 7, wherein:
at least one of the protocol processor, classifier, and traffic-shaping cell, are implemented as a semiconductor intellectual property and operate at run-time with the single queue.
